(19) United States
(12) Patent Application Publication
(10) Pub. No.: US 2021/0084885 A1
(43) Pub. Date: Mar. 25, 2021

(54) APPARATUS FOR SPRAY MANAGEMENT

(71) Applicant: BASF AGRO TRADEMARKS GMBH, Ludwigshafen am Rhein (DE)

(72) Inventors: Ole Peters, Langenfeld (DE); Matthias Tempel, Leverkusen (DE); Bjoern Kiepe, Köln (DE); Mirwaes Wahabzada, Langenfeld (DE)

(21) Appl. No.: 16/971,783

(22) PCT Filed: Feb. 27, 2019
(86) PCT No.: PCT/EP2019/054876

§ 371 Date: Aug. 21, 2020

(30) Foreign Application Priority Data
Mar. 2, 2018 (EP) 18159672.7

(51) Int. Cl. A01M 7/00

(52) U.S. Cl. CPC A01M 7/0089; A01M 7/0042

(57) ABSTRACT

The present invention relates to an apparatus for spray management. It is described to provide (210) a processing unit with at least one image of a field and provide (220) the processing unit with historical details relating to spray application of a weed control liquid and/or a pest control liquid to the field. The processing unit analyses (230) the at least one image to determine at least one location within the field for activation of at least one weed control spray gun and/or activation of at least one pest control spray gun. The processing unit determines (240) a configuration of the at least one weed control spray gun for application at the at least one location and/or a configuration of the at least one pest control spray gun for application at the at least one location. The determination comprises utilization of the historical details. Information is out-put (250) that is useable to activate the at least one weed control spray gun and/or the at least one pest control spray gun at the at least one location.

### FIELD OF THE INVENTION

The present invention relates to an apparatus for spray management, to a system for spray management, to a method for spray management, as well as to a computer program element and a computer readable medium.

### BACKGROUND OF THE INVENTION

The general background of this invention is weed control and pest control in agricultural environments. Chemical crop protection is an effective measure used to secure crop yield. However, resistance of certain weeds, fungal diseases and insect pests is an increasing problem. It is a challenging and time consuming task for a farmer to determine how to spray a field in view of with such increasing resistances.

### SUMMARY OF THE INVENTION

It would be advantageous to have improved apparatus for spray management.

The object of the present invention is solved with the subject matter of the independent claims, wherein further embodiments are incorporated in the dependent claims. It should be noted that the following described aspects and examples of the invention apply also for the apparatus for spray management, the system for spray management, the method for spray management, and for the computer program element and the computer readable medium.

According to a first aspect, there is provided an apparatus for spray management, comprising:
an input unit; and
a processing unit.

The input unit is configured to provide the processing unit with at least one image of a field. The input unit is configured also to provide the processing unit with historical details relating to spray application of a weed control liquid and/or a pest control liquid at the field. The processing unit is configured to analyse the at least one image to determine at least one location within the field for activation of at least one weed control spray gun and/or activation of at least one pest control spray gun. The processing unit is configured also to determine a configuration of the at least one weed control spray gun for application at the at least one location and/or a configuration of the at least one pest control spray gun for application at the at least one location. The determination comprises utilization of the historical details.

In an example, the apparatus comprises an output unit that is configured to output information useable to activate the at least one weed control spray gun and/or the at least one pest control spray gun at the at least one location.

In other words, existing historical knowledge relating to what weed/pest control has been applied to a field, and where it was applied within that field, is used along with present information acquired using image analysis to determine locations of weed/pests and this combined information can be used to determine how a weed control technology should be configured for application to the field. This could be the same control technology, or a different technology to that previously used. Thus, the efficacy of a chemical applied to a field can be taken into account when subsequently spraying the field. For example, if a particular chemical was applied at a location to kill particular weeds or insects and it is found that when returning to that location that the weeds or insects are still present or have returned sooner than expected, than a different chemical can be sprayed or the same chemical sprayed at a higher concentration. Also, if a particular chemical was sprayed at a location to kill weeds or insects, and returning to the field at a later date it is determined that at those locations the weeds or insects have been adequately controlled, a decision can be made to use the same chemical now for other locations where there are weeds or insects.

In this manner, historical knowledge is used with imaged processing of imagery to better enable chemicals to be applied to agricultural locations to control weeds and insects.

Thus, for a sprayer can spray a field with a herbicide treatment in spring for example. The sprayer could log details of where in the field the herbicide was sprayed, and this information is then part of historical details that can be subsequently used to spray the field. Subsequently, the sprayer, or a different sprayed could return to the field, and acquire imagery of the field that determines where weeds are growing. This information could be immediately used by the sprayer to apply a different herbicide to the weeds that were resistant to the first herbicide that was applied. However, the returning sprayer could be spraying a fungicide for example, but still capture imagery that can be analysed to determine where weeds are, and indeed what type of weeds they are. This information along with the knowledge of the herbicide that was first applied is then part of the historical details. Then, these historical details can be used later, for example a week or month later or indeed in the next year in the next weed emergence cycle, where on the basis of the historical details a different, more aggressive and possibly more expensive herbicide can be sprayed where it was determined that there were resistant weeds. Indeed, as resistances do not disappear the historical details can be used to inform spraying in subsequent growing seasons too.

In an example, the historical details comprises historical details relating to the at least one location. The determination of the configuration of the at least one weed control spray gun for application at the at least one location and/or the configuration of the at least one pest control spray gun for application at the at least one location comprises utilization of the historical details relating to the at least one location.

In an example, the analysis of the at least one image to determine the at least one location within the field for activation of the at least one weed control spray gun and/or activation of the at least one pest control gun comprises a determination of at least one weed and/or a determination of at least one pest. The determination of the configuration of the at least one weed control spray gun comprises utilization of the determined at least one weed and/or the determination of the configuration of the at least one pest control spray gun comprises utilization of the determined at least one pest.

In other words, a weed control spray gun can be activated at locations where weeds are determined to be from imaging processing and a pest control spray gun can be similarly activated at locations where pests are located. The activation also takes into account historical information relating to how the field, or different parts of the field, was/were previously sprayed.

In an example, the processing unit is configured to analyse the at least one image to determine a type of weed of the at least one weed at the at least one location and/or to determine a type of pest of the at least one pest at the at least one location. The determination of the configuration of the at least one weed control spray gun comprises utilization of the determined type of weed and/or wherein the determination of the configuration of the at least one pest control spray gun comprises utilization of the determined type of pest.

In this way locations can be sprayed in a manner that takes into account the specific weed or pest/insect that is found, and that also takes into account what was undertaken previously. In an example, the processing unit is configured to analyse an image of the at least one image to determine a location of a weed of the at least one weed in the image and/or determine a location of a pest of the at least one pest in the image.

In other words, an image will have an areal footprint on the ground, and by locating the weed/pest in the image, the actual position of the weed/pest can be determined to an accuracy better than the overall footprint of the image. Thus a weed control spray gun or pest control spray gun can be activated in a small area of a field associated with an acquired rather than be applied over the whole area of the field associated with that image.

In an example, the determination of the configuration of the at least one weed control spray gun comprises a determination of a herbicide to be sprayed at the at least one location and/or the determination of the configuration of the at least one pest control spray gun comprises a determination of a pesticide to be sprayed at the at least one location.

In this manner, for example a herbicide can be selected on the basis of weeds at locations in a field and that also takes into account historical information relating to application of a weed control liquid in the field. Also, in an example, a pesticide can be selected on the basis of pests at locations in a field and that also takes into account historical information relating to application of a pest control liquid in the field.

In an example, the herbicide is different to the weed control liquid and/or the pesticide is different to the pest control liquid.

In other words, weeds and/or pests can be determined to be at locations in a field, and historical information indicates that a particular herbicide and/or pesticide was sprayed in the field. A determination can then be made to use a different herbicide and/or pesticide to sprayed at locations where weeds/pests are located that can take into account the types of weeds/pests that have been determined to be at locations in the field.

In an example, the herbicide is the weed control liquid and/or the pesticide is the pest control liquid.

Thus, a determination can be made to persist with application of the same control liquid that was used previously.

In an example, the determination of the configuration of the at least one weed control spray gun comprises a determination of a dosage level of a herbicide to be sprayed at the at least one location and/or the determination of the configuration of the at least one pest control spray gun comprises a determination of a dosage level of a pesticide to be sprayed at the at least one location.

To put this another way, image processing is used to determine if weeds/pests are at locations, which can include the type of weed/pest. Using this information along with historical information relating to weed control/pest control liquids that were sprayed in the field, a dosage level can be appropriately selected. For example, a determination can be made that certain weeds/pests are developing a resistance, or have not been addressed through applications of specific chemicals.

New active ingredients can be applied, or previously used active ingredients can be applied, with the required dosage level being matched to that required to deal with the situation. In an example, analysis of the at least one image comprises utilisation of a machine learning algorithm.

In an example, the historical details relating to the application of the weed control liquid and/or the historical details relating to the application of the pest control liquid comprises at least one application location of the weed control liquid and/or at least one application location of the pest control liquid.

According to a second aspect, there is provided a system for spray management, comprising:
at least one camera;
an apparatus for spray management according to the first aspect;
at least one weed control spray gun and/or at least one pest control spray gun; and
at least one chemical reservoir.

The at least one camera is configured to acquire the at least one image of the field. The at least one weed control spray gun and/or at least one pest control spray gun is mounted on a vehicle. The at least one chemical reservoir is configured to hold a herbicide and/or pesticide. The at least one chemical reservoir is mounted on the vehicle. The at least one chemical reservoir is in fluid communication with the at least one weed control spray gun and/or is in fluid communication with the at least one pest control spray gun. The apparatus is configured to activate the at least one weed control spray gun to spray the herbicide and/or activate the at least one pest control spray gun to spray the pesticide.

In this way, a vehicle can move around and control weeds/pests as required. In this way, imagery can be acquired by one platform, for example one or more drones that fly over a field. That information is sent to an apparatus that could be in an office. The apparatus determines what locations of a field should be sprayed with herbicide/insecticide and how these should be sprayed. This information is provided to a vehicle that moves around that environment, and at specific parts of the field activates its spray gun(s) to spray herbicide/pesticide.

In an example, the apparatus is mounted on the vehicle, and the at least one camera is mounted on the vehicle.

In this manner, the system can operate in real time or quasi real time, where a vehicle acquires imagery, analyses it to where and in what manner a herbicide/pesticide should be sprayed, and then the vehicle can activate its spray gun(s) appropriately.

In an example, the system is configured to generate historical details relating to spray application of the herbicide and/or pesticide. The historical details comprise the at least one location where the herbicide was sprayed and/or the at least location where the pesticide was sprayed and comprises the configuration of the at least one weed control spray gun and/or the configuration of the at least one pest control spray gun.

According to a third aspect, there is provided a method for spray management, comprising:

a) providing a processing unit with at least one image of a field;
b) providing the processing unit with historical details relating to spray application of a weed control liquid and/or a pest control liquid to the field;
c) analysing by the processing unit the at least one image to determine at least one location within the field for activation of at least one weed control spray gun and/or activation of at least one pest control spray gun; and
e) determining by the processing unit a configuration of the at least one weed control spray gun for application at the at least one location and/or a configuration of the at least one pest control spray gun for application at the at least one location, wherein the determination comprises utilization of the historical details.

In an example, the method comprises the following step:

f) outputting output information useable to activate the at least one weed control spray gun and/or the at least one pest control spray gun at the at least one location.

According to another aspect, there is provided a computer program element for controlling an apparatus according to the apparatus of the first aspect and/or system according to the second aspect, which when executed by a processor is configured to carry out the method of the third aspect.

Advantageously, the benefits provided by any of the above aspects equally apply to all of the other aspects and vice versa.

The above aspects and examples will become apparent from and be elucidated with reference to the embodiments described hereinafter.

### BRIEF DESCRIPTION OF THE DRAWINGS

Exemplary embodiments will be described in the following with reference to the following drawings:

FIG. 1 shows a schematic set up of an example of an apparatus for spray management;

FIG. 2 shows a schematic set up of an example of a system for spray management;

FIG. 3 shows a method for spray management; and

FIG. 4 shows a schematic representation of weeds that have been sprayed and weeds that are to be sprayed.

### DETAILED DESCRIPTION OF EMBODIMENTS

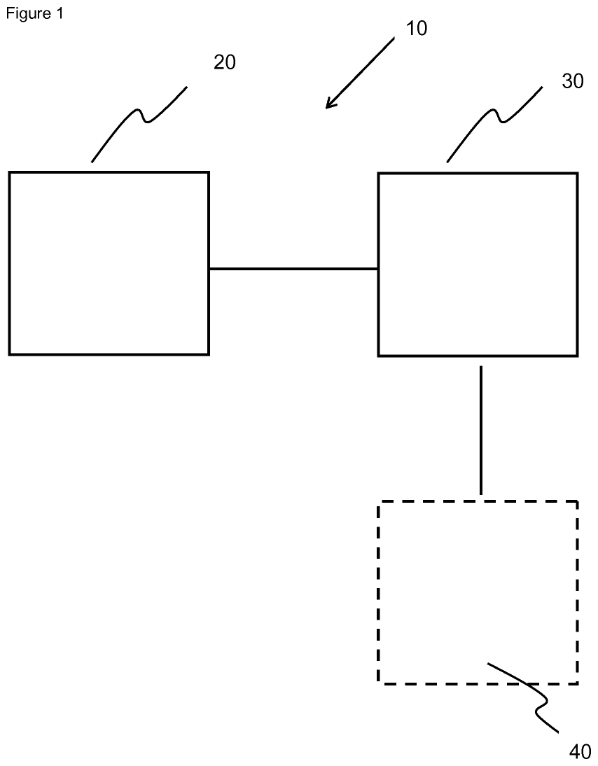

FIG. 1 shows an example of an apparatus 10 for spray management. The apparatus 10 comprises an input unit 20, a processing unit 30. The input unit 20 is configured to provide the processing unit 30 with at least one image of a field. The input unit 20 is configured also to provide the processing unit 30 with historical details relating to spray application of a weed control liquid and/or with historical details relating to spray application of a pest control liquid at the field. The processing unit 30 is configured to analyse the at least one image to determine at least one location within the field for activation of at least one weed control spray gun and/or configured to analyse the at least one image to determine at least one location within the field for activation of at least one pest control spray gun. The processing unit 30 is configured to determine a configuration of the at least one weed control spray gun for application at the at least one location and/or configured to determine a configuration of the at least one pest control spray gun for application at the at least one location. Either or both determinations comprise utilization of the historical details.

According to an example, the apparatus comprises an output unit 40. The output unit 40 is configured to output information useable to activate the at least one weed control spray gun and/or the at least one pest control spray gun at the at least one location.

According to an example, the historical details comprises historical details relating to the at least one location. The determination of the configuration of the at least one weed control spray gun for application at the at least one location and/or the determination of the configuration of the at least one pest control spray gun for application at the at least one location comprises utilization of the historical details relating to the at least one location.

In an example, the apparatus is operating in real-time, where images are acquired and immediately processed and a decision is immediately made to spray a location of the field. Thus, for example a vehicle can acquire imagery of its environment and process that imagery to determine if different locations of a field are to be sprayed or not. Thus, for example a UAV can fly around a field and acquire imagery and determine if areas of a field should be sprayed or not, via for example one or more a spray guns located on the UAV. Thus, for example a robotic land vehicle can move around a field and acquire imagery and determine if areas of the field should be sprayed or not, via for example one or more spray guns located on the robotic land vehicle. In an example, the apparatus is operating in quasi real time, where images are acquired of a field and immediately processed to determine if locations in the field should be sprayed or not.

That information can later be used by an appropriate system (or systems) that travel(s) within the field and uses spray gun(s) to spray those locations. Thus for example, a first vehicle, such as an unmanned aerial vehicle (UAV) or drone equipped with one or more cameras can travel within a field and acquire imagery. This imagery can be immediately processed to determine areas or locations to be sprayed. Thus in effect a “weed map and/or pest map”, is generated detailing the locations to be sprayed to control weeds/pests. Later, a vehicle can travel within the field and spray the locations previously determined to require spraying. Thus for example, a UAV with a chemical spray gun then flies to the location of the weeds that need to be controlled and sprays weeds, or a robotic land vehicle travels within the field and uses its spray gun to spray plants to control pests such as fungicides or insects.

In an example, the apparatus is operating in an offline mode. Thus, imagery that has previously been acquired is provided later to the apparatus. The apparatus then determines which areas are to be sprayed, to in effect generate a weed/pest map of specific weeds/pests and their locations. The weed/pest map is then used later by one or more vehicles that then travel within the field and activate their spray guns at the appropriate locations.

In an example, the at least one pest comprises a fungicide. In an example, the at least one pest comprises an insect, such as an aphid.

According to an example, the analysis of the at least one image to determine the at least one location within the field for activation of the at least one weed control spray gun and/or, the analysis of the at least one image to determine the at least one location within the field for activation of the at least one pest control gun comprises a determination of at least one weed and/or a determination of at least one pest. The determination of the configuration of the at least one weed control spray gun comprises utilization of the determined at least one weed and/or the determination of the configuration of the at least one pest control spray gun comprises utilization of the determined at least one pest.

According to an example, the processing unit is configured to analyse the at least one image to determine a type of weed of the at least one weed at the at least one location and/or is configured to analyse the at least one image to determine a type of pest of the at least one pest at the at least one location. The determination of the configuration of the at least one weed control spray gun comprises utilization of the determined type of weed and/or the determination of the configuration of the at least one pest control spray gun comprises utilization of the determined type of pest.

According to an example, the processing unit is configured to analyse an image of the at least one image to determine a location of a weed of the at least one weed in the image and/or is configured to analyse an image of the at least one image to determine a location of a pest of the at least one pest in the image.

According to an example, the determination of the configuration of the at least one weed control spray gun comprises a determination of a herbicide to be sprayed at the at least one location and/or wherein the determination of the configuration of the at least one pest control spray gun comprises a determination of a pesticide to be sprayed at the at least one location. According to an example, the herbicide is different to the weed control liquid and/or the pesticide is different to the pest control liquid.

According to an example, the herbicide is the weed control liquid and/or the pesticide is the pest control liquid.

According to an example, the determination of the configuration of the at least one weed control spray gun comprises a determination of a dosage level of a herbicide to be sprayed at the at least one location and/or wherein the determination of the configuration of the at least one pest control spray gun comprises a determination of a dosage level of a pesticide to be sprayed at the at least one location.

In an example, the dosage level of the herbicide comprises a concentration of the herbicide. In an example, the dosage level of the pesticide comprises a concentration of the pesticide.

In an example, the dosage level of the herbicide comprises a duration of activation of a weed control spray gun.

In an example, the dosage level of the pesticide comprises a duration of activation of a pest control spray gun.

In an example, the at least one image was acquired by at least one camera, and wherein the input unit is configured to provide the processing unit with at least one geographical location associated with the at least one camera when the at least one image was acquired.

Thus imagery can be acquired by one platform, that could analyse it to determine locations to be sprayed. For example a UAV can fly around a field and acquire and analyse the imagery. Then the information of the locations to be sprayed can be used by a second platform, for example a robotic land vehicle that goes to the locations and sprays those locations. Thus, by correlating an image with the geographical location where it was acquired, the spray guns can be accurately activated there, whether activation is done by the same or a different platform that determined the locations to be sprayed.

In an example, a GPS unit is used to determine the location of the at least one camera when specific images were acquired.

In an example, an inertial navigation unit is used alone, or in combination with a GPS unit, to determine the location of the at least one camera when specific images were acquired. In an example, image processing of acquired imagery is used alone, or in combination with a GPS unit, or in combination with a GPS unit and inertial navigation unit, to determine the location of the at least one camera when specific images were acquired. Thus visual markers can be used alone, or in combination with a GPS unit and/or an inertial navigation unit to determine the location of the at least one camera when specific images were acquired.

According to an example, analysis of the at least one image comprises utilisation of a machine learning algorithm.

In an example, the machine learning algorithm comprises a decision tree algorithm. In an example, the machine learning algorithm comprises an artificial neural network. In an example, the machine learning algorithm has been taught on the basis of a plurality of images. In an example, the machine learning algorithm has been taught on the basis of a plurality of images containing imagery of at least one type of weed. In an example, the machine learning algorithm has been taught on the basis of a plurality of images containing imagery of a plurality of weeds. In an example, the machine learning algorithm has been taught on the basis of a plurality of images containing imagery of at least one type of pest and/or plant that is affected by a pest. In an example, the machine learning algorithm has been taught on the basis of a plurality of images containing imagery of a plurality of pests and/or plants affected by pests.

The imagery acquired by a camera is at a resolution that enables one type of weed to be differentiated from another type of weed, and that enables one type of pest to be differentiated from another type of pest, and that enables one type of plant affected by a pest to be differentiated from the same plant affected by another type of pest. Thus a vehicle, such as a UAV, with a camera can fly around a field and acquire imagery. The UAV (drone) can have a Global Positioning System (GPS) and this enables the location of acquired imagery to be determined. The drone can also have inertial navigation systems, based for example on laser gyroscopes. The inertial navigation systems can function alone without a GPS to determine the position of the drone where imagery was acquired, by determining movement away from a known or a number of known locations, such as a charging station. The camera passes the acquired imagery to the processing unit. Image analysis software operates on the processing unit. The image analysis software can use feature extraction, such as edge detection, and object detection analysis that for example can identify structures such in and around the field such as buildings, roads, fences, hedges, etc. Thus, on the basis of known locations of such objects, the processing unit can patch the acquired imagery to in effect create a synthetic representation of the environment that can in effect be overlaid over a geographical map of the environment. Thus, the geographical location of each image can be determined, and there need not be associated GPS and/or inertial navigation-based information associated with acquired imagery. In other words, an imagebased location system can be used to locate the drone. However, if there is GPS and/or inertial navigation information available then such image analysis, that can place specific images at specific geographical locations only on the basis of the imagery, is not required. Although, if GPS and/or inertial navigation-based information is available then such image analysis can be used to augment the geographical location associated with an image.

The processing unit therefore runs image processing software that comprises a machine learning analyser. Images of specific plants with pests/pests/weeds are acquired. Information relating to a geographical location in the world, where such a pest/weed is to be found and information relating to a time of year when that pest/weed is to be found, including when in flower and size and/or growth stage of an insect etc. can be tagged with the imagery. The machine learning analyser, which can be based on an artificial neural network or a decision tree analyser, is then trained on this ground truth acquired imagery. In this way, when a new image of vegetation is presented to the analyser, where such an image can have an associated time stamp such as time of year and a geographical location such as Germany or South Africa tagged to it, the analyser determines the specific type of weed that is in the image through a comparison of imagery of a weed found in the new image with imagery of different weeds it has been trained on, where the size of weeds, and where and when they grow can also be taken into account. The specific location of that weed type on the ground within the environment, and its size, can therefore be determined. Similarly, imagery of plants that are affected by pests, such as fungicides or insects, can be used to determine that there are pests present and what the pests are, and indeed imagery of insects themselves can be used to determine that such pests are present.

Thus, the UAV can fly around a field and acquire imagery from which weeds and pests can be detected and identified, and a decision is made on where in a field a herbicide or pesticide should be sprayed and how the specific liquids to be sprayed should be formulated and/or applied. This information is then later used by another vehicle, that has spray guns, to enter the field and spray the determined locations.

With respect to the UAV described above that acquires imagery, the UAV could itself have the spray guns. The UAV can therefore acquire the imagery, process it to determine where herbicides or pesticides should be sprayed and in what form or in what manner they should be sprayed, and the sprays those locations.

Also, with respect to the land robot, that is entering the field, this vehicle can have a camera and acquire the imagery that is used to determine where and in what manner locations in the field are to be sprayed.

The processing unit has access to a database containing different weed types, different pest types and different plants affected by different pests. This database has been compiled from experimentally determined data.

The vehicle could be a robotic land vehicle,

According to an example, the historical details relating to the application of the weed control liquid and/or the historical details relating to the application of the pest control liquid to the field comprises at least one application location of the weed control liquid and/or comprises at least one application location of the pest control liquid.

In an example, the historical details relating to the application of the weed control technology and/or the pest control technology to the field comprises an identity of at least one type of weed and/or an identity of at least one type of pest at the at least one application location. In an example, the historical details relating to the application of the weed control technology and/or the pest control technology to the field comprises at least one dosage level of the weed control liquid and/or the pest control liquid.

In an example, the historical details relating to the application of the weed control liquid and/or the pest control liquid to the field comprises at least one application location of a herbicide that is different to the weed control liquid and/or a pesticide that is different to the pest control liquid.

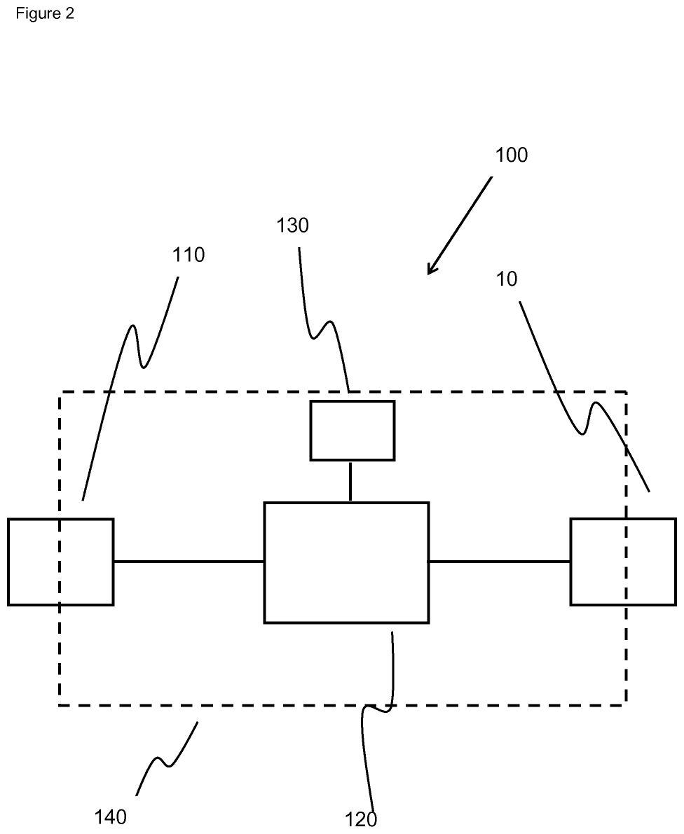

FIG. 2 shows an example of a system 100 for spray management. The system 100 comprises at least one camera 110, an apparatus 10 for spray management as described with respect to FIG. 1. The system 100 also comprises at least one weed control spray gun and/or at least one pest control spray gun 120 and at least one chemical reservoir 130. The at least one camera 110 is configured to acquire the at least one image of the field. The at least one weed control spray gun and/or at least one pest control spray gun 120 is mounted on a vehicle 140. The at least one chemical reservoir 130 is configured to hold a herbicide and/or pesticide. The at least one chemical reservoir 130 is in fluid communication with the at least one weed control spray gun and/or the at least one pest control spray gun 120. The apparatus 10 is configured to activate the at least one weed control spray gun 120 to spray the herbicide and/or activate the at least one pest control spray gun 120 to spray the pesticide.

In an example, the apparatus is mounted on the vehicle; and the at least one camera is mounted on the vehicle.

In an example, the system is configured to generate historical details relating to spray application of the herbicide and/or pesticide, the historical details comprising the at least one location where the herbicide was sprayed and/or where the pesticide was sprayed and the configuration of the at least one weed control spray gun and/or the configuration of the at least one pest control spray gun.

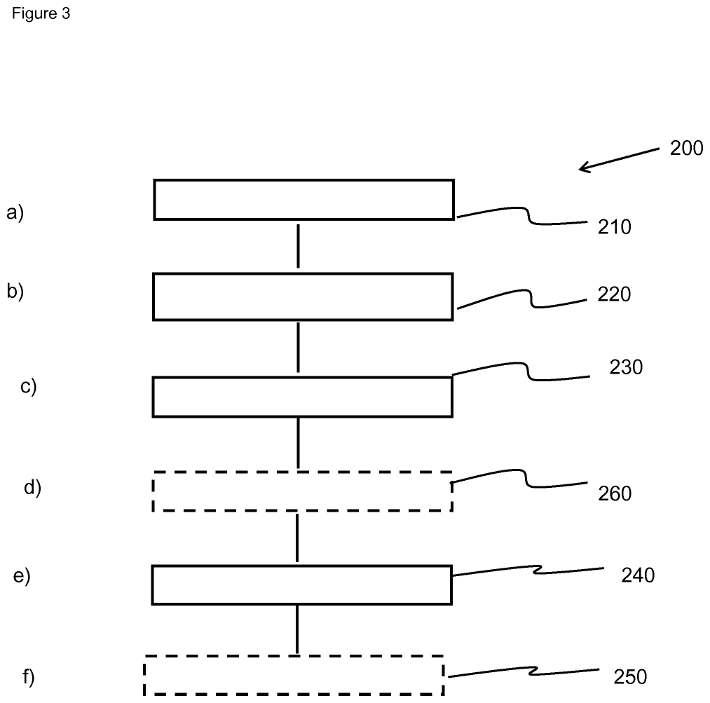

FIG. 3 shows a method 200 for spray management in its basic steps. The method 200 comprises:

in a providing step 210, also referred to as step a), providing a processing unit with at least one image of a field;

in a providing step 220, also referred to as step b), providing the processing unit with historical details relating to spray application of a weed control liquid and/or a pest control liquid to the field;

in an analyzing step 230, also referred to as step c), analysing by the processing unit the at least one image to determine at least one location within the field for activation of at least one weed control spray gun and/or activation of at least one pest control spray gun; and in a determining step 240, also referred to as step e), determining by the processing unit a configuration of the at least one weed control spray gun for application at the at least one location and/or a configuration of the at least one pest control spray gun for application at the at least one location, wherein the determination comprises utilization of the historical details.

In an example, the method comprises an outputting step 250, also referred to as step f), that comprises outputting information useable to activate the at least one weed control spray gun and/or the at least one pest control spray gun at the at least one location.

In an example, the historical details comprise historical details relating to the at least one location and wherein step e) comprises utilizing the historical details relating to the at least one location.

In an example, step c) comprises a determination of at least one weed and/or a determination of at least one pest; and wherein step e) comprises utilization of the determined at least one weed and/or comprises utilization of the determined at least one pest.

In an example, step c) comprises analysing the at least one image to determine a type of weed of the at least one weed at the at least one location and/or to determine a type of pest of the at least one pest at the at least one location; and wherein step e) comprises utilization of the determined type of weed and/or comprises utilization of the determined type of pest. In an example, the method comprises step d) analysing 260 an image of the at least one image to determine a location of a weed of the at least one weed in the image and/or determine a location of a pest of the at least one pest in the image.

In an example, step e) comprises a determination of a herbicide to be sprayed at the at least one location and/or comprises a determination of a pesticide to be sprayed at the at least one location.

In an example, in step e) the herbicide is different to the weed control liquid and/or the pesticide is different to the pest control liquid.

In an example, in step e) the herbicide is the weed control liquid and/or the pesticide is the pest control liquid.

In an example, step e) comprises a determination of a dosage level of a herbicide to be sprayed at the at least one location and/or comprises a determination of a dosage level of a pesticide to be sprayed at the at least one location.

In an example, step c) comprises utilising a machine learning algorithm.

In an example, the historical details relating to the application of the weed control liquid and/or the historical details relating to the application of the pest control liquid to the field comprises at least one application location of the weed control liquid and/or the pest control liquid.

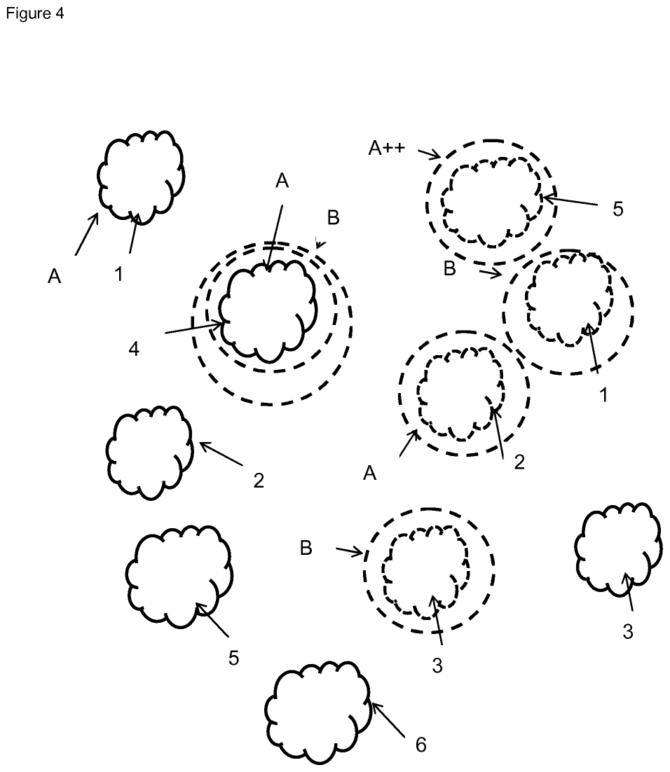

FIG. 4 shows functioning of the apparatus, for the example of application of herbicides to a field. The dashed circles shows where herbicides have historically be sprayed. Weeds are also shown, where a solid outlined weed is a weed that has been determined through image processing to be in existence at a particular location and a weed with a dashed outline is a weed that once existed and is known to have existed at locations from historical information, but image processing of acquired imagery can find no trace of it.

Thus, in FIG. 4 a weed of type 1 has been found at a location and that weed was previously sprayed with herbicide A. Therefore, this herbicide may not at that applied strength level be appropriate to kill the weed at this round of spraying. However, a weed of type 1 was controlled through spraying with herbicide B, and a decision can be made to spray weed 1 with herbicide B. A new weed of type 2 has also been found using image processing, and historically this weed was controlled using herbicide A. Therefore, a decision can be made to spray this weed with herbicide A. Similarly, a new weed of type 3 has also been found using image processing, and historically this weed was controlled using herbicide B. Therefore, a decision can be made to spray this weed with herbicide B. A weed 4 has previously been sprayed with both herbicides A and B but is still alive at that location and a decision should be made to use a different herbicide or one of those herbicides at a stronger dosage level. Regarding increased dosage levels, a weed of type 5 had previously been controlled with a stronger mix of herbicide A (A++), and a newly detected weed of this type could be sprayed with such a strong mix. A new wed of type 6 has also been detected via image processing, and there is no historical information relating to this weed. However, this weed belongs to the family of weeds that the weed of type 1 belongs to, and this information can be used in determining what herbicide to use, and a decision to use herbicide B is made.

Image processing to enable analysis to determine a weed type

A specific example of how an image is processed, and determined to be suitable for image processing in order that a type of weed can be determined is now described:
1. A digital image—in particular a colored image—of a weed is captured.
2. Areas with a predefined color and texture within the digital image are contoured within a boundary contour. Typically, one may expect one contoured area from one weed plant. However, there may also be more than one contoured area from different, potentially not connected leafs, from two weed plants, or the like. —Such a detection or determining process detects boundaries of green areas of the digital image. During this process at least one contoured area—e.g., one or more leafs, as well as one or more weed plants—may be built comprising pixels relating to the weed within a boundary contour. However, it may also be possible, that the digital image has captured more than one leaf and/or the stem. Consequently, more than one contoured area may be determined.
3. Determining if the boundary contour covers a large enough area, and determining a sharpness (e.g. degree of focus) of the image data within the boundary contour. This firstly ensures that there will be sufficient image data upon which a determination can be made as to the type of weed, and secondly determines that a minimum quality of the digital image will be satisfied in order that the type of weed can be made.
4. If both criteria in 3) are satisfied, the digital image, and specifically that within the boundary contour is sent to the processing unit for image analysis by the artificial neural network to determine the type of weed as described above.

In another exemplary embodiment, a computer program or computer program element is provided that is characterized by being configured to execute the method steps of the method according to one of the preceding embodiments, on an appropriate system.

The computer program element might therefore be stored on a computer unit, which might also be part of an embodiment. This computing unit may be configured to perform or induce performing of the steps of the method described above. Moreover, it may be configured to operate the components of the above described apparatus and/or system. The computing unit can be configured to operate automatically and/or to execute the orders of a user. A computer program may be loaded into a working memory of a data processor. The data processor may thus be equipped to carry out the method according to one of the preceding embodiments.

This exemplary embodiment of the invention covers both, a computer program that right from the beginning uses the invention and computer program that by means of an update turns an existing program into a program that uses invention.

Further on, the computer program element might be able to provide all necessary steps to fulfill the procedure of an exemplary embodiment of the method as described above.

According to a further exemplary embodiment of the present invention, a computer readable medium, such as a CD-ROM, USB stick or the like, is presented wherein the computer readable medium has a computer program element stored on it which computer program element is described by the preceding section.

A computer program may be stored and/or distributed on a suitable medium, such as an optical storage medium or a solid state medium supplied together with or as part of other hardware, but may also be distributed in other forms, such as via the internet or other wired or wireless telecommunication systems.

However, the computer program may also be presented over a network like the World Wide Web and can be downloaded into the working memory of a data processor from such a network. According to a further exemplary embodiment of the present invention, a medium for making a computer program element available for downloading is provided, which computer program element is arranged to perform a method according to one of the previously described embodiments of the invention.

It has to be noted that embodiments of the invention are described with reference to different subject matters. In particular, some embodiments are described with reference to method type claims whereas other embodiments are described with reference to the device type claims. However, a person skilled in the art will gather from the above and the following description that, unless otherwise notified, in addition to any combination of features belonging to one type of subject matter also any combination between features relating to different subject matters is considered to be disclosed with this application. However, all features can be combined providing synergetic effects that are more than the simple summation of the features.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims. In the claims, the word “comprising” does not exclude other elements or steps, and the indefinite article “a” or “an” does not exclude a plurality. A single processor or other unit may fulfill the functions of several items re-cited in the claims. The mere fact that certain measures are recited in mutually different dependent claims does not indicate that a combination of these measures cannot be used to advantage. Any reference signs in the claims should not be construed as limiting the scope.

1. An apparatus for spray management, comprising:
an input unit; and
a processing unit;
wherein, the input unit is configured to provide the processing unit with at least one image of a field;
wherein, the input unit is configured to provide the processing unit with historical details relating to spray application of a weed control liquid and/or a pest control liquid at the field; wherein, the processing unit is configured to analyse the at least one image to determine at least one location within the field for activation of at least one weed control spray gun and/or activation of at least one pest control spray gun; and
wherein, the processing unit is configured to determine a configuration of the at least one weed control spray gun for application at the at least one location and/or a configuration of the at least one pest control spray gun for application at the at least one location, wherein the determination comprises utilization of the historical details.

2. Apparatus according to claim 1, wherein the apparatus comprises an output unit, and wherein, the output unit is configured to output information useable to activate the at least one weed control spray gun and/or the at least one pest control spray gun at the at least one location.

3. Apparatus according to any of claim 1, the historical details comprises historical details relating to the at least one location, and wherein the determination of the configuration of the at least one weed control spray gun for application at the at least one location and/or the configuration of the at least one pest control spray gun for application at the at least one location comprises utilization of the historical details relating to the at least one location.

4. Apparatus according to any of claim 1, wherein the analysis of the at least one image to determine the at least one location within the field for activation of the at least one weed control spray gun and/or activation of the at least one pest control gun comprises a de-termination of at least one weed and/or a determination of at least one pest; and wherein the determination of the configuration of the at least one weed control spray gun comprises utilization of the determined at least one weed and/or wherein the determination of the configuration of the at least one pest control spray gun comprises utilization of the determined at least one pest.

5. Apparatus according to claim 4, wherein the processing unit is configured to analyse the at least one image to determine a type of weed of the at least one weed at the at least one location and/or to determine a type of pest of the at least one pest at the at least one location; and wherein the determination of the configuration of the at least one weed control spray gun comprises utilization of the determined type of weed and/or wherein the determination of the configuration of the at least one pest control spray gun comprises utilization of the determined type of pest.

6. Apparatus according to claim 4, wherein the processing unit is configured to analyse an image of the at least one image to determine a location of a weed of the at least one weed in the image and/or determine a location of a pest of the at least one pest in the image.

7. Apparatus according to claim 4, wherein the determination of the configuration of the at least one weed control spray gun comprises a determination of a herbicide to be sprayed at the at least one location and/or wherein the determination of the configuration of the at least one pest control spray gun comprises a determination of a pesticide to be sprayed at the at least one location.

8. Apparatus according to claim 7, wherein the herbicide is different to the weed control liquid and/or wherein the pesticide is different to the pest control liquid.

9. Apparatus according to claim 7, wherein the herbicide is the weed control liquid and/or wherein the pesticide is the pest control liquid.

10. Apparatus according to claim 4, wherein the determination of the configuration of the at least one weed control spray gun comprises a determination of a dosage level of a herbicide to be sprayed at the at least one location and/or wherein the determination of the configuration of the at least one pest control spray gun comprises a determination of a dosage level of a pesticide to be sprayed at the at least one location.

11. Apparatus according to claim 1, wherein the historical details relating to the application of the weed control liquid and/or the pest control liquid to the field comprises at least one application location of the weed control liquid and/or the pest control liquid.

12. A system for spray management, comprising:
at least one camera;
an apparatus for spray management according to claim 1;
at least one weed control spray gun and/or at least one pest control spray gun and at least one chemical reservoir;
wherein, the at least one camera is configured to acquire the at least one image of the field;
wherein, the at least one weed control spray gun and/or at least one pest control spray gun is mounted on a vehicle;
wherein, the at least one chemical reservoir is configured to hold a herbicide and/or pesticide;
wherein, the at least one chemical reservoir is in fluid communication with the at least one weed control spray gun and/or the at least one pest control spray gun; and
wherein, the apparatus is configured to activate the at least one weed control spray gun to spray the herbicide and/or activate the at least one pest control spray gun to spray the pesticide.

13. System according to claim 12, wherein the apparatus is mounted on the vehicle; and wherein the at least one camera is mounted on the vehicle.

14. System according to claim 12, wherein the system is configured to generate historical details relating to spray application of the herbicide and/or pesticide, the historical details comprising the at least one location where the herbicide was sprayed and/or where the pesticide was sprayed and the configuration of the at least one weed control spray gun and/or the configuration of the at least one pest control spray gun.

15. A method for spray management, comprising:
a) providing a processing unit with at least one image of a field;
b) providing the processing unit with historical details relating to spray application of a weed control liquid and/or a pest control liquid to the field;
c) analysing by the processing unit the at least one image to determine at least one location within the field for activation of at least one weed control spray gun and/or activation of at least one pest control spray gun; and
e) determining by the processing unit a configuration of the at least one weed control spray gun for application at the at least one location and/or a configuration of the at least one pest control spray gun for application at the at least one location, wherein the determination comprises utilization of the historical details.
